(19) United States
(12) Patent Application Publication
(10) Pub. No.: US 2006/0011659 A1
(43) Pub. Date: Jan. 19, 2006

(54) Dispenser for media

(76) Inventors: Juergen Greiner-Perth, Gottmadingen (DE); Peter Koenig, Rielasingen/Worblingen (DE); Stefan Ritsche, Eigeltingen (DE); Miro Cater, Daytona Beach, FL (US)

Correspondence Address: FLYNN THIEL BOUTELL & TANIS, P.C., 2026 RAMBLING ROAD, KALAMAZOO, MI, 49008-1631, US

(21) Appl. No.: 11/180,292

(22) Filed: Jul. 13, 2005

(30) Foreign Application Priority Data
Jul. 13, 2004 (DE) 102004035141.4
Feb. 22, 2005 (DE) 102005009294.2

(51) Int. Cl. B65D 88/54; G01F 11/06; G01F 11/30; G01F 11/36; G01F 11/42

(52) U.S. Cl. 222/321.7

(57) ABSTRACT

In a dispenser for liquid media, applicator of the dispenser is fixed to a medium reservoir. A finger rest for actuating the dispenser is configured such that it is axially displaceable relative to this subassembly. As advantageous refinements, a dispenser is proposed whose pump is realized as a user-independent pump, a variety of mechanical realizations being considered advantageous.

### FIELD OF THE INVENTION

The invention relates to a dispenser for media having a medium reservoir, an applicator having at least one discharge opening, a finger rest, which can be manually subjected to force, and a pump having at least two pump parts which are axially movable relative to each other.

### BACKGROUND OF THE INVENTION

Such dispensers are used, above all, for liquids, suspensions, pastes and foams and serve for the dosed discharge of these media. In the medical field, such dispensers are also used, inter alia, for nasal applications, in which the applicator is realized such that it can be inserted in the nose so as to deliver liquids or suspensions therein.

In the prior art, for example in DE 19940234 A1, primarily such dispensers of the generic type are known in which the applicator and the finger rest are realized in one piece, so that a relative movement of the finger rest relative to the medium reservoir also constitutes, at the same time, a relative movement of the applicator relative to the medium reservoir. These dispensers are usually operated with one hand, the medium reservoir of the dispenser being clasped with the hand and held stationary relative to the particular body part, for example the nose, while the finger rest is operated with one or two fingers. A perceived drawback with this is that, during the discharge operation, the applicator with the discharge opening departs from its original position relative to the particular body part, or the discharge operation is triggered following the departure of the applicator from its original position. In the case of a nasal application, this results, for example, in the nose applicator being withdrawn from the nose, which adversely affects the delivery of the medium. Although this can be offset by readjustment of the medium reservoir, this is difficult from the motory aspect and reduces the convenience of use of the dispenser.

### SUMMARY OF THE INVENTION

The object of the invention is therefore to provide a media dispenser of the type stated in the introduction, which allows greater convenience of use compared with the prior art.

This object is achieved by the applicator being fixedly connected to the medium reservoir and the finger rest being axially movable relative to the medium reservoir and the applicator between a first, unpressed operating end position and a second, pressed operating end position.

In such a dispenser according to the invention, the applicator and the media reservoir form a, during use, one-piece unit, which dictates that the discharge opening shall be at a fixed and non-variable position relative to the medium reservoir. The medium reservoir serves to accommodate at least one medium. A position of the medium reservoir which is fixed relative to the particular body part during use also therefore results in a fixed position of the discharge opening. In the case of a nose applicator for nasal applications, the discharge opening of the applicator remains, for example, at is position defined prior to the start of the discharge operation by the insertion of the applicator into the nose. The finger rest can be moved in translatory motion relative to this one-piece unit comprising medium reservoir and applicator. The principal axis of this translatory mobility is preferably identical with a longitudinal axis of the applicator. The applicator and the medium reservoir can be provided as a one-piece component, but are preferably separate components which are detachably joined together, for example by a screw joint. In a particularly preferred embodiment, a connecting element for connecting the applicator to the medium reservoir, in particular a screw fastening, is provided. The pump is preferably disposed within the applicator and has a dosing chamber, which is limited, at least partially, by the applicator. The volume of the dosing chamber is determined by a pump piston operatively connected to the finger rest, both a direct connection between piston and finger rest and an operative connection via intermediate elements being possibly expedient. Depending on the embodiment, the filling of the dosing chamber with medium originating from the medium reservoir can be realized in the course of the pressing of the finger rest or with the return of the finger rest into its original setting. The same applies to the discharging of the medium present in the dosing chamber.

In a preferred refinement of the invention, the pump is realized in such a way that a constant discharge stroke can be obtained independently of a manual operating force.

In a user-independent pump of this kind, the discharge operation for the medium present in the dosing chamber is not influenced by the characteristics of the operating process. This is preferably achieved by the finger rest and a pump piston of the pump not being joined together in one piece and being able to be mutually separated by kinematic means. Hence, an actuation of the finger rest does not directly result in a diminution of the volume of the dosing chamber of the pump. Instead, the applied energy is stored and is utilized only at a later point to compress the medium present in the dosing chamber, for example once a defined actuating position has been reached. It is precisely in those applications in which the quantity of medium to be discharged and the nature of the discharge operation, for example by spraying, must be strictly adhered to that this independence from the manner of operation by the user is expedient.

In a refinement of the invention which is based on the above, a carrier is provided, which is connected in a non-detachable manner to a pump piston, the applicator, the carrier and/or the finger rest having coupling means which are configured to create an axial coupling state between the carrier and the finger rest in the region of a first pump stroke end position assigned to the first operating end position, and to create a decoupled state of carrier and finger rest in the region of a second stroke end position assigned to the second operating end position, and the carrier being subjected to a spring force in the direction of the first stroke end position.

The carrier, which is connected in a non-detachable manner to the pump piston, directly determines the volume of the dosing chamber. It can be moved both relative to the applicator and relative to the finger rest in the direction of the principal axis. In the first stroke end position of its movement relative to the applicator, the dosing chamber of the pump has a minimum volume. In its second stroke end position, the dosing chamber has a maximum volume. As a result of the force subjected upon the carrier, it is forced in the direction of its first stroke end position, i.e. the end position having minimum dosing chamber volume. The opposite direction of the carrier in the direction of the second stroke end position is obtained by coupling the carrier motion to the operating motion of the finger rest. The coupling means provided for this purpose are configured such that, in the region of the first stroke end position or of the first operating end position, they provoke a coupling between the finger rest and the carrier, so that, during the maintenance of this coupling state during operation, the carrier is tensioned against the action of the spring force, and such that, when the stroke end position is reached, they release this coupling, so that the carrier which has thus been pretensioned is transferred back by the spring force into the first stroke end position. As a result of the movement of the carrier from the second stroke end position back into the first stroke end position, the volume of the dosing chamber is reduced and a discharge operation necessitated. For this discharge operation, it is not important for the finger rest to be meanwhile returned into its first operating end position. This can also be done after the conclusion of the discharge operation. As soon as the finger rest has regained the first operating end position, the coupling between carrier and finger rest is restored—preferably automatically.

In a preferred refinement of the invention, the coupling means have a time-delay means, by which, following decoupling of the carrier from the finger rest in the region of the second stroke end position, a retarded return stroke motion is obtained.

By a retarded return stroke motion is meant a return stroke motion which is retarded relative to a return stroke motion which, in terms of its temporal progression, is dependent merely upon the spring force and the pressure in the dosing chamber. Such a retardation can be expedient, in particular, where a certain discharge characteristic is to be obtained or where a filling operation of the dosing chamber is not to be prematurely interrupted by the return stroke of the piston in the direction of the first stroke end position. The time-delay means can be configured such that they display a time-delay effect only in a part-region of the stroke, in particular in a part-region adjoining the second stroke end position. A possible realization of the time-delay means provides guide elements, which, in the course of the return stroke motion of the carrier, cause the stroke motion to be overlaid with a rotary motion about a pump longitudinal axis.

In a refinement of the invention, the coupling means on the carrier have at least one latching element, preferably at least one latch boss, which can be coupled to the finger rest in such a way that a movement of the finger rest from the first operating end position to the second operating end position produces a movement of the carrier from the first pump stroke end position to the second pump stroke end position, and further have a decoupling section, which, in the region of the stroke end position, decouples the latching means from the finger rest, preferably by radial deflection of the latch boss.

Embodiments of the dispenser according to this refinement are very simply constructed in terms of their design. The latching element provided on the carrier preferably extends radially outward into the region of the finger rest, so that, in the course of the pressing of the finger rest, it latch locks with the latter in a manner which allows a joint movement of the finger rest and the carrier in the direction of the second operating end position. Special preference is given to the use of an elastically configured latch boss as the latching element. This is radially deflected, once the second operating end position is reached, to the point where it is no longer engaged with the finger rest and, consequently, the carrier, which in this state is pretensioned by the spring force, is forced in the direction of its first stroke end position. Depending on the embodiment, the deflected latch boss hereupon slides down on an inward-pointing contact surface of the finger rest. In this case, the finger rest and the latch boss can be designed such that the friction force opposite to the spring force, generated by the contact of the latch boss with this surface, is low. Following the discharge operation or during the discharge operation, the finger rest, preferably spring-aided, can be returned into the first operating end position, in which the latch boss of the carrier gets back into the non-deflected engagement setting with the finger rest. Alternatively thereto, the elastic latching element can also be provided on the finger rest side and, in the region of a stroke end position, can be deflected radially outward by a decoupling apparatus on the applicator side.

In another refinement of the invention, the applicator and the finger rest are configured such that they are rotationally secure one to the other with respect to a principal axis, and the carrier, in a first guide section adjacent to the first stroke end position, is secured against twisting relative to the applicator, at least in a rotational direction about the principal axis, and, in a second triggering section adjacent to the second stroke end position, are configured such that they can be twisted in this rotational direction, guide means being provided, which, following attainment of the state decoupled from the finger rest, guide the carrier in an overlaid rotary and translatory motion back into the first stroke end position.

In this refinement it is also envisaged that, in the course of the actuating motion of the finger rest, the finger rest and the carrier are guided in a fixed rotational alignment to each other and to the applicator until the stroke end position is reached. While the finger rest remains connected to the applicator in a rotationally secure manner, even following the attainment of the stroke end position, the carrier, from the moment the stroke end position is reached, is rotationally movable relative to the applicator about the principal axis. The guide means have the effect that the return stroke motion of the carrier, provoked by the, in this state, high spring force, is overlaid with a rotary motion. As a result of this rotary motion, the carrier, during the return stroke, is rotated relative to the applicator and the finger rest about the principal axis. Following the return of the finger rest into the first operating end position, the carrier then re-enters, in the first stroke end position, a state in which it is rotationally secured and coupled to the finger rest. A particularly preferred embodiment envisages that the guide means are formed by sawtooth-shaped projections, which extend on the inner wall of the applicator in circular arrangement about the longitudinal axis of the applicator. The teeth are here separated from one another by longitudinally aligned grooves on the inner wall of the applicator. The grooves are used in the guide section of the stroke for the rotational securement of the carrier by means of carrier-side coupling sections. Where appropriate, they can additionally be used, also in the same manner, for the rotational securement of coupling sections on the finger rest side. The coupling sections of the carrier and of the finger rest have mutually facing beveled coupling surfaces, the gradient of which preferably conforms to that of the sawteeth. When the dispenser is actuated by depression of the finger rest, the coupling surfaces bear flush one against the other. As a result of the oblique shaping of the coupling surfaces, a torque hereupon acts upon the carrier, which, due to the guidance of the coupling sections in the grooves between the sawteeth or owing to the longitudinally aligned, vertical flanks of the sawteeth, does not lead to a rotation of the carrier. Once the tip of the sawteeth is reached, the carrier-side coupling section then slides down, however, on the coupling surface on the finger rest side and the oblique flank of the sawteeth, thereby producing a combined translatory and rotary motion of the carrier. Once the finger rest has regained its first operating end position, the carrier-side coupling section reengages with the coupling section on the finger rest side. The advantage of this refinement according to the invention lies, on the one hand, in the fact that it constitutes a time-delay means of the above-described type, i.e. retards the return stroke of both the carrier and the piston, which is expedient, in particular, in respect of a time-critical upstream filling of the dosing chamber and that, on the other hand, compared with a variant of the coupling means with latching elements, no elastic components are needed and are deformed in the course of their operation. A failure of the dispenser due to damage to elastically deflected components is thereby avoided.

In a refinement of the invention, the pump piston fixedly connected to the carrier limits, jointly with a cylindrical pump wall and a front-side end wall of the applicator, a dosing chamber of the pump.

This constitutes a very simple construction of the pump. For the supply of medium into the dosing chamber, a connecting line to the medium reservoir is provided, this supply line being able to be opened and closed in dependence on the stroke position of the piston and/or the pressure in the dosing chamber. The pump is additionally connected to the discharge opening by a connecting line and, where appropriate, further elements which influence the discharge operation.

In a refinement of the invention, the carrier is connected by an inlet valve to the medium reservoir, which, if the dosing chamber pressure is lower than the pressure in the medium reservoir, opens. Such a valve prevents medium from flowing off into the medium reservoir in the course of actuation of the dispenser.

In a refinement of the invention, the carrier and/or the applicator is/are configured such that the dosing chamber, in a first isolating stroke section adjacent to the first stroke end position, is separated from the medium reservoir and, in a thereto adjoining connecting stroke section, is connected to the medium reservoir.

In the region of the isolating stroke section, upon an actuating motion from the first to the second operating end position, the volume of the dosing chamber is effectively enlarged without the medium meanwhile making its way into the dosing chamber. Instead, an underpressure or a vacuum is developed in the dosing chamber and the dosing chamber is only filled with medium once the connecting stroke section is reached. This procedure is advantageous compared with a continuous filling of the dosing chamber, since varying liquid quantities in the course of different operating motions are avoided. Instead, an always identical underpressure ratio is produced in the dosing chamber, which results in an only very slightly fluctuating quantity of medium in the dosing chamber after the connecting stroke section is reached. Upon the movement of the piston from the second stroke end position into the first stroke end position, i.e. during the diminution of the volume of the dosing chamber, the piston gets back into the isolating stroke section, in which it is separated from the medium reservoir. From the time of separation, no medium can make its way back into the medium reservoir. The medium quantity present in the dosing chamber at the time of the passage from the connecting stroke section into the isolating stroke section is consequently used for the following discharge operation.

In a refinement of the invention, the dosing chamber, in a second isolating stroke section preceding the stroke end position, is separated from the medium reservoir.

The effect of this separation in the second isolating stroke section is that the maximum volume of the medium which has flowed into the dosing chamber is defined not by the stroke end position, but by the second isolating stroke section. A higher accuracy is thereby obtained, since, depending on the mechanical construction of the coupling means, the stroke end position can fluctuate to an undesirably high extent, which likewise results in a fluctuation of the medium stored in the dosing chamber.

In a refinement of the invention, the dispenser has a discharge valve, which is operatively connected to the finger rest by mechanical means and is configured such that it opens in a stroke intermediate position, before or as the second stroke end position is reached.

Such a discharge valve allows a purposeful discharge of the medium once a pressure optimal for the discharge is reached. In contrast to a discharge valve which is opened in dependence on a discharge pressure, a discharge valve which is operatively connected to the finger rest by mechanical means is opened when a certain position of the finger rest is reached. A discharge valve can also be opened when there has been failure to reach a desired target pressure. Moreover, a discharge valve of this type is suitable for use in dispensers of different construction or different purpose, which have a mutually differing discharge pressure.

In a refinement of the invention, between the dosing chamber and the discharge opening a pressure chamber is provided, which is separated from the dosing chamber by a pressure-actuated intermediate valve.

In a dispenser having such a construction, the path of the medium runs from the medium reservoir through the dosing chamber into the pressure chamber. From the pressure chamber, the medium is then discharged. In such a construction, the dosing chamber is preferably configured such that its minimum volume is very small relative to the maximum volume. This allows very high pressures to be generated in the dosing chamber, which cause the medium to be transported into the pressure chamber. From this, the medium can only escape on the discharge opening side. Without medium discharge, the pressure in the pressure chamber therefore rises further with each pump stroke until a target discharge pressure is reached. Such an apparatus eliminates the risk that air within a dosing chamber will be compressed with each pump stroke and will be decompressed again with the return stroke, without any medium being consequently discharged. In such a case, it is virtually impossible to start using the dispenser without a rising pressure developing—as, in this refinement, in the pressure chamber—since the pressure ratios in the dosing chamber in respect of each pump stroke are identical.

In a refinement of the invention, the discharge valve is configured in such a way that in the open state, from a discharge limit pressure of the medium, it maintains the open state, this limit pressure, in the case of a discharge valve actuated by the pressure of the medium, preferably being less than the opening limit pressure necessary to open the valve.

The consequence is that the valve remains open even at a discharge pressure which is insufficient to open the valve. In a valve, in particular, which can be opened mechanically and not by pressure, it is expedient to provide such a design. The effect of this design is that the mechanical force by which the valve is opened does not have to be maintained for the period of the discharge. If this mechanical force is exerted directly by means of the finger rest of the dispenser, the use of such a discharge valve means that a premature release of the finger rest does not result in interruption of the discharge.

In a refinement of the invention, the valve has an actuating surface, the pressurized portion of which in the open state of the valve is greater than in the closed state of the valve.

Depending on the embodiment, the pressurized portion in the closed state of the valve can also be sufficiently small that, at operating pressures which are standard in the dispenser, an opening of the valve is not achieved on the basis of the pressure, but instead can only be realized mechanically. If the valve is open, however, this pressurized portion is greater, so that the open state is able to be maintained until the discharge pressure has fallen to the point where, despite the enlarged actuating portion, a closure of the valve—for example by a spring force—is performed. This spring force, once again, is accompanied by a diminution of the actuating surface.

### BRIEF DESCRIPTION OF THE DRAWINGS

Further features and advantages of the invention emerge from the claims and the description in association with the drawings, in which:

FIGS. 1 to 3 show a first embodiment of a dispenser according to the invention in three stages of an actuating operation,

FIG. 4 shows a second embodiment of a dispenser according to the invention, which operates on the basis of a dosing chamber filling principle which is changed from the first two embodiments,

FIG. 5 shows a third embodiment of the invention having a pressure chamber separated by the dosing chamber, and

FIGS. 6a to 7b show a fourth embodiment of a dispenser according to the invention in two different stages of the actuating operation and respectively in a perspective view and a sectional view.

### DETAILED DESCRIPTION OF THE INVENTION

In the context of this description, “at the top” or “upward” is used to denote a direction toward the discharge openings represented at the top in the figures, and “at the bottom” or “downward” is used to denote a direction toward the medium reservoirs (not represented in the drawings) adjoining, at the bottom, the respectively represented discharge apparatuses.

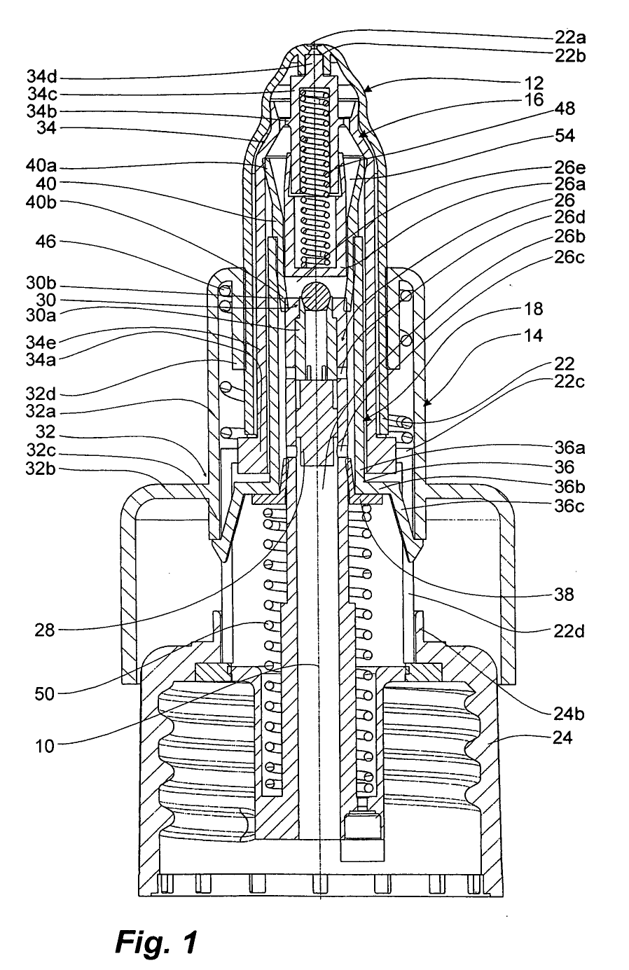

FIGS. 1 to 3 show a first embodiment of a discharge apparatus of a dispenser according to the invention, in which the medium reservoir belonging to the dispenser is not represented. The figures show various stages during an actuating operation for the conveyance of a medium present in the medium reservoir.

The discharge apparatus essentially has four subassemblies 12, 14, 16, 18, which are configured such that they are axially mutually displaceable along a principal axis 10. The subassemblies in question are an applicator subassembly 12, a finger rest subassembly 14, a discharge valve subassembly 16 and a piston subassembly 18.

The finger rest subassembly 14 is configured such that it is axially displaceable relative to the applicator subassembly 12 between a first, upper actuating end position and a second, lower actuating end position. The discharge valve subassembly 16 is configured such that it is axially displaceable relative to the applicator subassembly 12 between an upper closing position and a lower opening position. The piston subassembly 18 is configured such that it is axially displaceable relative to the applicator subassembly 12 between a first, upper stroke end position and a second, lower stroke end position. The applicator subassembly 12 itself is fixedly connected to the medium reservoir (not represented in the figures).

The applicator subassembly 12 consists of a substantially cylindrical nose applicator 22 having a discharge opening 22a disposed at the upper end, a screw fastening 24, by which the nose applicator 22 is connected to a medium reservoir (not represented), a medium supply apparatus 26, disposed within the screw fastening 24 and the nose applicator 22 and comprising an axially aligned medium duct 26b, as well as a blocking insert 28 disposed in the medium duct 26b and an inlet valve piece 30a likewise disposed in the medium duct 26 over the blocking insert 28. Above the inlet valve piece 30a there is provided in the medium supply apparatus a radial through bore 26e, through which medium fed through the medium duct 26 can make its way into a dosing chamber 54. Above and below the blocking insert 28, radial through bores 26c, 26d are provided in the medium supply, which allow the blocking insert 28 to be by-passed in the course of the conveyance of the medium. Disposed in the through bore 26e is a ball valve 30b, which, together with the inlet valve piece 30a, forms a ball seat valve 30, which opens when an underpressure obtains in the dosing chamber 54.

The components 22, 24, 26, 28, 30 of the applicator subassembly 12 are fixedly connected to one another and are configured such that their relative position does not alter if the dispenser is used according to specification.

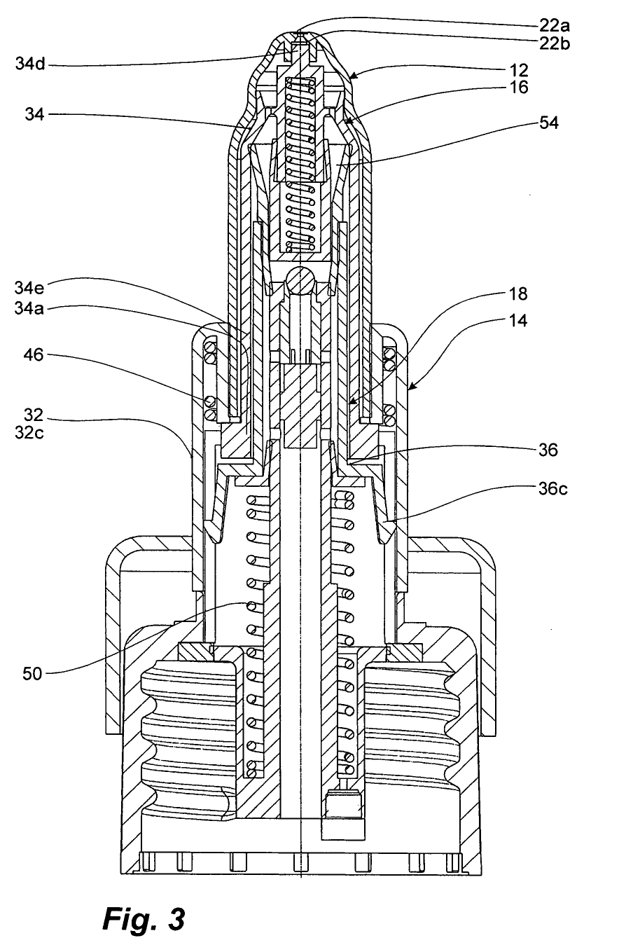

The second subassembly, the finger rest subassembly 14, consists merely of the finger rest 32. The finger rest 32 has a cylindrical section, having a cylindrical wall 32a, and an actuating section 32b, extending radially therefrom, for the resting of the fingers. The cylindrical section is of double-walled construction in an upper region and has an inner wall 32d. The lower end of the cylindrical wall 32a constitutes a functional section 32c, the working of which will be further described later. The finger rest 32 is slipped onto the applicator subassembly 12 from outside and is axially movable relative to the latter between a first actuating end position, represented in FIG. 1, and a second actuating end position, represented in FIG. 3.

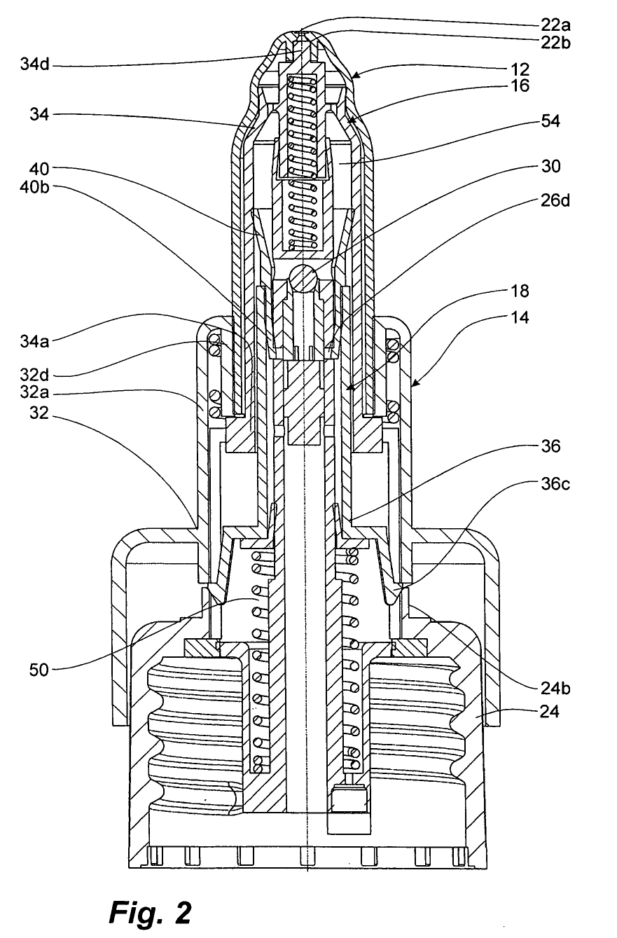

The third subassembly, the discharge valve subassembly 16, has a one-piece valve element 34 having a cylindrical main section 34e. At the lower end of the main section 34e there is provided an actuating ring 34a. At the upper end of the main section 34e, an upwardly closed inner cylinder 34c is integrated, via radial webs 34b, integrally into the valve element 34. At the upper end of this inner cylinder 34c, a closing pin 34d, extending axially upward, is molded onto the inner cylinder 34c. The valve element 34 is axially displaceable relative to the applicator subassembly 12. The upper end position of the valve element 34, represented in FIGS. 1 and 2, constitutes a closing state, in which the closing pin 34d, in the region of the discharge opening 22a of the nose applicator 22, bears flush against an annular surface 22b of the nose applicator 22 and thereby prevents a medium discharge through the discharge opening 22a. The lower end position of the valve element 34 relative to the applicator subassembly 12, represented in FIG. 3, constitutes the opening state in which the annular surface 22b of the nose applicator 22 and the closing pin 34d are spaced apart in the direction of the principal axis 10, enabling pressurized medium to escape through the discharge opening 22a.

The last subassembly, the piston subassembly 18, consists of a total of three components. These components are a carrier 36, a sealing ring 38 and a piston packing 40. These components 36, 38, 40 are fixedly connected to one another and do not alter their relative position if the dispenser is used according to specification. The carrier 36 has a cylindrical section 36a, adjoined at the lower end by an outward-pointing radial section 36b. Molded onto this radial section 36b are latch bosses 36c, which extend outward away from the principal axis 10. The latch bosses 36c are of elastic configuration and are formed such that they can be deflected radially inward. In the region of the transition between the cylindrical section 36a and the radial section 36b of the carrier 36, the latter is fixedly connected to the inner sealing ring 38. The upper end of the carrier 36 is adjoined by the piston packing 40, which consists of an elastic material. The piston packing 40 has a substantially cylindrical basic form, exhibiting the greatest external diameter at its upper end 40a and the smallest internal diameter at its lower end 40b. It is connected to the carrier 36 in such a way that its lower end 40b is disposed inside the cylindrical section 36a and its upper end projects upward over the carrier 36. The piston subassembly 18 is disposed within the nose applicator 22 and the discharge valve subassembly 16 is disposed in the discharge apparatus and encloses the medium supply apparatus 26. The sealing ring 38 and the lower end 40b of the piston packing 40 are configured such that they form a tight inward seal against the medium supply apparatus. The upper end 40a of the piston packing 40 is configured such that it forms a tight outward seal against the inner side of the main section 34e of the valve element 34. The piston subassembly 18 is configured such that it is displaceable between a first, upper stroke end position and a second, lower stroke end position, the first, upper stroke end position being determined by a stop position of the piston packing 40 at the end of the cylindrical section 34e of the valve element 34 and the lower stroke end position being defined by a decoupling web 24b of the screw fastening 24 of the applicator subassembly 12, against which the latch bosses 36c are forced radially inward out of the operative connection with the functional section 32c of the finger rest 32, thereby preventing any further movement of the piston subassembly 18 in the downward direction. This is explained in greater detail further below.

The discharge apparatus represented in FIGS. 1 to 3 has a total of three springs, by which the finger rest 32, the valve element 34 and the piston subassembly 18, relative to the applicator subassembly 12, are subjected to force in the direction of their respectively upper end position. The finger rest 32 is forced upward by the finger rest spring 46, which is supported on an annular shoulder 22c of the nose applicator 22. The valve element 34 is forced into its closing position by a valve spring 48, the valve spring 48 being held in a downwardly closed-off cylindrical supporting section 26a at the upper end of the medium supply apparatus 26, and in the inner cylinder 34c of the valve element 34. The piston subassembly 18 is acted upon by an energy store spring 50 in the direction of its first, upper stroke end position.

The described discharge apparatus represented in FIGS. 1 to 3 functions as a user-independent discharge apparatus. This means that the dosing quantities and the discharge pressure are independent of the manner of the actuation by the operator.

The working method of the described dispenser is set to be illustrated with reference to the sequence of FIGS. 1 to 3:

FIG. 1 shows the dispenser in a starting position. The finger rest 32, the valve element 34 and the piston subassembly 18 are found respectively—acted upon by the respective springs 46, 48, 50—in their upper end position. In this upper end position, the functional section 32c of the finger rest 32 is disposed above the latch bosses 36c of the carrier 36 of the piston subassembly 18. The latch bosses 36c are in a non-deflected state and extend through axially aligned cutouts 22d in the nose applicator 22 to below the functional sections 32c of the finger rest 32. The dosing chamber 54 located between the piston packing 40 and the dosing element 34 has, in this stage, a minimum volume.

Starting off from this state, the finger rest 32 is pressed downward by an operator relative to the applicator subassembly 12 and counter to the spring force of the finger rest spring 46. Since the latch bosses 36c are disposed beneath the functional sections 32c, the piston subassembly 18, too, is likewise forced downward jointly with the finger rest 32. This produces a volume enlargement of the dosing chamber 54. The underpressure which is thereby formed opens the ball seat valve 30 and draws medium into the dosing chamber 54. This medium, starting from the medium reservoir (not represented in the figures), hereupon takes a path through the medium duct 26b of the medium supply apparatus 26, through the lower through bores 26c beneath the blocking insert 28 out of the medium supply apparatus 26, and through the upper through bores 26d above the blocking insert 28 back into the medium supply apparatus 26. With progressive displacement of the finger rest 32 in the downward direction and the parallel displacement of the piston subassembly 18 in the downward direction, the dosing chamber 54, accordingly, is increasingly filled. Meanwhile, the energy store spring 50, which subjects the piston subassembly 18 to an upwardly directed force, is increasingly compressed and, hence, tensioned. An unwanted escape of the medium outward in the section between the first through bores 26c and the second through bores 26d is prevented by the sealing ring 38 and the lower end 40b of the piston packing 40, which tightly seal, at the bottom and top respectively, an annular through chamber, which is closed off on the inside by the medium supply apparatus and on the outside by the valve element. An escape of the medium through the discharge opening is not possible during this phase of the actuation, since the closing pin 34d bears flush against the annular surface 22b of the nose applicator 22 and thus seals the discharge opening 22a.

FIG. 2 shows a state of the dispenser in the first embodiment shortly before the start of the discharge operation. The finger rest 32 is here pressed so far downward that the lower end 40b of the piston packing 40 covers the upper through bores 26d and thus prevents a further influx of medium into the dosing chamber 54. The piston subassembly 18 is displaced, together with the finger rest 32, sufficiently far down that the latch bosses 36c have made their way into that region of the cylindrical decoupling web 24b which is molded onto the screw fastening 24 and, as the finger rest 32 and the piston subassembly 18 are progressively pressed down, are deflected radially inward by the said decoupling web. The contact surface between the functional section 32c of the finger rest 32 and the latch bosses 36c of the carrier 36, commencing with the time of initial contact between the latch bosses 36c and the decoupling web 24b, therefore becomes increasingly small.

The result is that, as the finger rest 32 is progressively pressed down, the functional section. 32c loses contact with the latch bosses 36c and these spring onto the inner surface of the cylindrical wall 32a of the finger rest 32. From this moment, the piston subassembly 18 can be forced upward without hindrance from the energy store spring 50. The latch bosses 36c hereupon slide upward along with it, on the inner side of the cylindrical wall 32a of the finger rest 32. As a result of the action by the spring force of the energy store spring 50, the medium in the dosing chamber 54 is pressurized, an escape of the medium back into the medium reservoir being prevented by the ball seat valve 30.

The movement of the finger rest 32 up to an actuating end position, in which the functional section 32c of the finger rest 32 rests upon the decoupling web 24b of the screw fastening 24, has the effect, apart from the decoupling of the latch bosses 36c from the functional sections 32c, that the downward-pointing front face of the cylindrical inner wall 32d of the finger rest 32 forces the actuating ring 34a of the valve element 34, and hence the entire valve element 34, downward. Consequently, the closing pin 34d is lifted off downward from the annular surface 22b of the nose applicator 22 and the discharge opening 22a for the medium present in the dosing chamber 54 is thereby made accessible.

FIG. 3 shows a state toward the end of the medium discharge. The medium present in the dosing chamber 54 is forced out of the discharge opening 22a by the pressure generated by the energy store spring 50 and thus escapes in a precisely defined quantity. The discharge operation ends when the piston packing 40 butts against the end of the cylindrical section 34e of the valve element 34 and the dosing chamber 54 can consequently be diminished no further. Once the discharge operation is concluded, the finger rest 32 is guided back upward and released by the operator and is consequently forced upward by the tensioned spring rest spring 46. Once the finger rest 32 has reached the upper actuating end position, the functional section 32c is located, once again, above the latch bosses 36c of the carrier 36 of the piston subassembly 18. The latch bosses 36c are therefore forced outward back into a non-deflected position and thus reengage with the finger rest 32. The starting state for a further actuation is thus achieved.

It should particularly be emphasized with this first embodiment that the medium quantity in the dosing chamber 54 is not determined by the lower stroke end position, in which the latch bosses 36c disengage from the functional sections 32c of the finger rest 32, but is instead defined by the setting from which the lower ends 40b of the piston packing 40b seal off the upper through bores 26d of the medium feed 26. A particularly high dosing accuracy is thereby achieved, since the dosing accuracy is not dependent on the position in which the latch bosses 36c disengage from the functional sections 32c, which position varies to a certain extent. The second peculiarity of this embodiment lies in the fact that the discharge valve formed by the closing pin 34d and the annular surface 22b of the nose applicator 22 is not opened on a pressure-dependent basis. Instead, an opening of the discharge valve is compelled by the fact that the actuating ring 34a of the valve element 34 is forced downward directly by the finger rest 32. The advantage with this solution is that the discharge valve does not need to be specially adapted for dispensers of different type and of different maximum pressure in the dosing chamber.

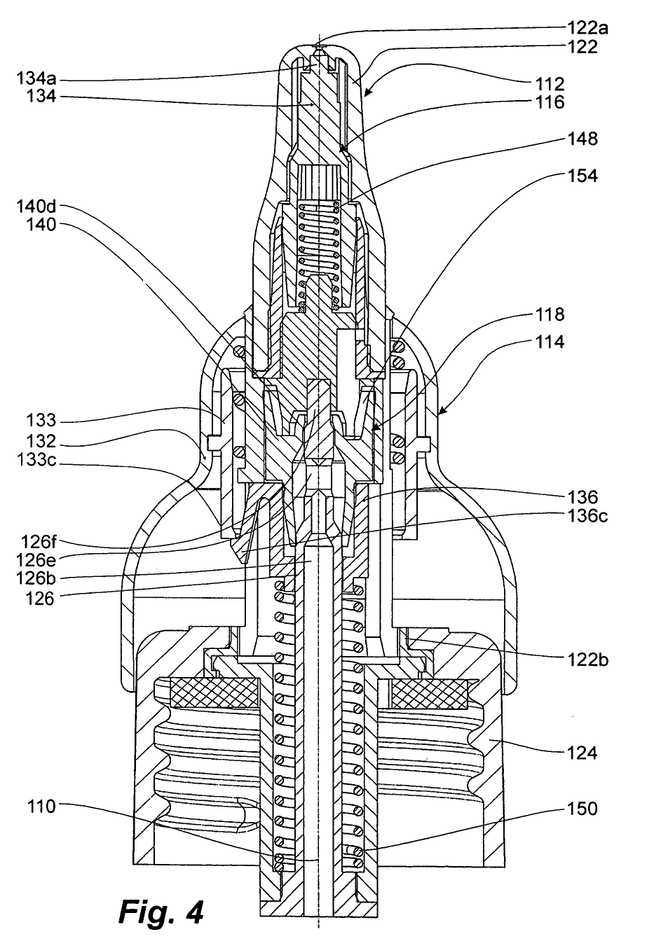

FIG. 4 shows a second embodiment of a discharge apparatus of a dispenser according to the invention.

Just like the first embodiment represented in FIGS. 1 to 3, this second embodiment has four mutually displaceable subassemblies, an applicator subassembly 112 having a nose applicator 122, a finger rest subassembly 114, a discharge valve subassembly 116 and a piston subassembly 118 having a valve element 134. With respect to the interaction of the finger rest subassembly 114 and the piston subassembly 118 in the coupling and decoupling of the subassemblies, the working method of this second embodiment is consistent with the working method of the embodiment of FIGS. 1 to 3: When a finger rest 132 is pressed down, a cylindrical guide section 133, fixedly connected to the finger rest 132 and having a functional section 133c, is forced jointly downward. This functional section 133c forces downward the piston subassembly 118, which is operatively connected by a latch boss 136c to the finger rest subassembly 114. Upon this—similarly to the first embodiment—an energy store spring 150 is compressed. Once a cylindrical decoupling web 122b is reached by the latch boss 136c in the course of the finger rest subassembly 114 being pressed down, the latch boss 136c is forced radially inward and thus enters a state decoupled from the functional section 133c. The piston subassembly 118 can then be forced upward by the energy store spring 150, whereupon the volume of a dosing chamber 154 is reduced and the medium present therein is pressurized.

This represented second embodiment differs from the first embodiment of FIGS. 1 to 3 particularly in respect of two aspects:

On the one hand, the displacement of the valve element 134 with the closing pin 134d is pressure-dependent and the discharge valve is therefore pressure-activated, so that the discharge automatically takes place once a necessary limit pressure is reached in the dosing chamber. On the other hand, the actuating operation differs in terms of the process of filling the dosing chamber 154 with the medium.

While the first embodiment of FIGS. 1 to 3 envisages that the dosing chamber 54, as a result of the generated underpressure, is immediately filled in the course of the actuation, in this second embodiment it is envisaged that, as a result of the actuation, a pronounced underpressure or a vacuum is generated in the dosing chamber 154, which is subsequently used, in the course of the actuation, to suck in the medium. For this purpose, a medium supply device 126, in this second embodiment, is designed such that, in the starting position represented in FIG. 4, no connection exists between the dosing chamber 154 and a medium duct 126b. This is achieved by a configuration of a piston packing 140 belonging to the piston subassembly, which piston packing, in this starting position, bears with an inward-pointing sealing web 140d, which limits the dosing chamber 154 in the downward direction, flush against a sealing cylinder 126f adjoining the medium supply device at the top. In the course of the finger rest 132 being pressed down and of the piston packing 140 being displaced to the same extent, the dosing chamber 154 is enlarged with respect to its volume, the sealing web 140d terminating, over a first part-section of the movement, with the sealing cylinder 126f. Only once the piston packing 140 or the sealing web 140d of the piston packing 140 makes its way into the region of a through bore 126e of the medium supply apparatus 126 is a direct and uninterrupted connection established between the medium reservoir and the dosing chamber 154. Due to the underpressure developed in the dosing chamber 154, the medium flows at this moment out of the medium reservoir through the medium duct 126b into the dosing chamber 154. After the latch boss 136c is forced inward against the decoupling web 122b and is freed from engagement with the functional section 132c, as the finger rest 132 continues to be pressed down, the piston subassembly 118, and hence the piston packing 140, darts upward under the action of the energy store spring 150. At the moment in which the sealing section 140d comes back into the region of the sealing cylinder 126f, the dosing chamber 154 is separated from the medium reservoir. From this moment, the pressure in the dosing chamber 154 is increased as a result of the reduction in volume and the force subjected upon the cylinder subassembly. As soon as the pressure in the dosing chamber has exceeded a discharge limit value, the valve element 134, and the closing pin 134d molded thereto, is forced downward counter to the spring force of a valve spring 148, and the discharge operation commences through a discharge opening 122a. The discharge operation is continued until such time as the dosing chamber 154 is completely reduced in size and the pressure in the dosing chamber 154 has fallen below this limit value and the closing pin 134d of the valve element 134 seals off the discharge opening again.

The peculiarity of this second embodiment lies in the manner in which the medium is conveyed into the dosing chamber. Differently than in the first embodiment, in which the conveyance commences simultaneously with the displacement of the piston packing 40, in this second embodiment a vacuum or a pronounced underpressure is firstly developed in the dosing chamber 154, which, in the further course of the actuation, leads to the conveyance of a defined quantity of the medium.

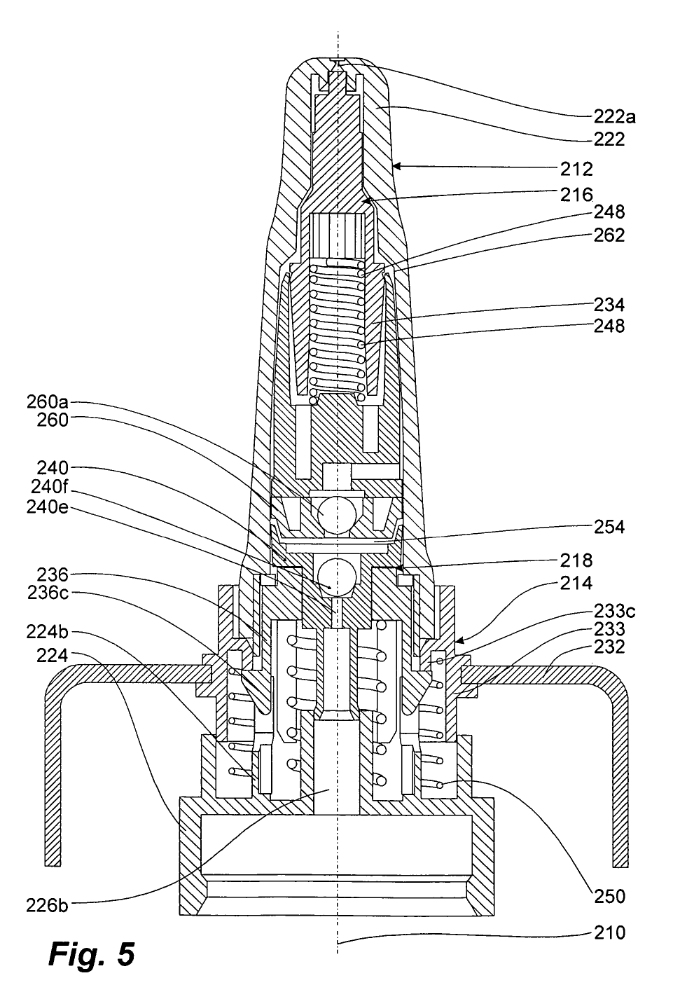

FIG. 5 shows a third embodiment of a discharge apparatus of a dispenser according to the invention. This—just like the first two embodiments—has four mutually separate subassemblies. An applicator subassembly 212 having a nose applicator 222 is in this case fixedly connected, in a non-represented manner, to a medium reservoir. A finger rest subassembly 214 is arranged such that it is axially displaceable in the direction of a principal axis 210 relative to the applicator subassembly 212. Within the applicator subassembly 212, a discharge valve subassembly 216 and a piston subassembly 218 are arranged such that they are axially displaceable relative to the applicator subassembly 212.

The finger rest subassembly comprises a finger rest 232 and a cylindrical guide section 233 having an inward-jutting functional section 233c. The piston subassembly 218 consists of a carrier 236 and a piston packing 240. The carrier 236 has, at the lower end, latch bosses 236c, which, in a non-deflected state, as represented in FIG. 5, are extended radially outward into the region of the functional section 233c. Above the piston packing 240 there is disposed a dosing chamber 254, which is closed off in the upward direction by a wall insert 260 belonging to the applicator subassembly 212. Through a through duct 240e in the piston packing 240, the dosing chamber 254 is connected by a medium duct 226b to the medium reservoir (not represented in FIG. 5). Above the through duct 240e, a ball seat valve 240f is provided, which is configured such that it closes when a pressure higher than that in the medium reservoir obtains in the dosing chamber 254. The wall insert 260 which closes off the dosing chamber 254 in the upward direction separates the dosing chamber 254 from a pressure chamber 262. Medium can make its way out of the dosing chamber 254, via a second ball seat valve 260a, into this pressure chamber 262. The second ball seat valve 260a is here configured such that it opens when the pressure in the dosing chamber 254 is greater than the pressure in the pressure chamber 262. When the pressure in the pressure chamber 262 has exceeded a discharge limit pressure, a valve element 234 of the discharge valve subassembly 216 is displaced in the axially downward direction axially counter to an upward-acting spring force of a valve spring 248, thereby enabling the medium to be sprayed through the discharge opening 222a.

The working method of this embodiment, as far as the generation of the pressure in the dosing chamber 254 is concerned, is broadly comparable with the first embodiment represented in FIGS. 1 to 3. The finger rest 232, once again, is pressed manually downward, whereupon the piston subassembly 218, because of the coupling of the latch bosses 236c to the functional sections 233c, is likewise forced downward. As in the illustrative embodiment of FIGS. 1 to 3, medium hence flows into the dosing chamber 254, since the ball seat valve 240f opens due to the underpressure obtaining in the dosing chamber 254 as a result of the volume enlargement. Unlike the second described embodiment, the discharge valve is not, however, opened in dependence on the pressure obtaining in the dosing chamber 254, but instead in dependence on a pressure obtaining in the pressure chamber 262. When, following the decoupling of the latch bosses 236c from the functional sections 233c by means of decoupling sections 224b, a volume diminution of the dosing chamber and an accompanying pressure increase within the dosing chamber 254 takes place, medium is conveyed from the dosing chamber 254 into the pressure chamber 262. Insofar as the pressure which is thereby created in the pressure chamber 262 is not yet sufficient to open the discharge valve, the medium present in the pressure chamber 262 remains in the pressure chamber 262 until a subsequent next actuation of the dispenser, since the valve 260a prevents the medium from flowing back into the dosing chamber 254 or into the medium reservoir. As long as the discharge valve does not open, the pressure within the pressure chamber 262 can consequently only keep on rising upon subsequent actuations of the discharge apparatus. Once the pressure in the pressure chamber 262 is high enough, each further actuation of the dispenser and each further quantity of the medium supplied via the dosing chamber 254 leads always to a discharge process. When the dispenser comprising such a discharge apparatus is first used, it has therefore to be actuated a few times until the pressure in the pressure chamber 262 is sufficient to effect a discharge operation.

The advantage with the represented embodiment is that, as a result of the separation of pressure chamber 262 and dosing chamber 254, the volume of the dosing chamber 254 in the non-actuated state is relatively small. The result of this is that the pressure in the dosing chamber rises very strongly in the course of the actuation. The pressure in the pressure chamber 262 increases incrementally with each actuation of the discharge apparatus, until such time as the limit pressure necessary to open the discharge valve is reached. In this way, very high discharge pressures and corresponding discharge characteristics of the dispenser are able to be attained.

Due to its construction with two valves 240f, 260a, the discharge apparatus represented in FIG. 5 can therefore be superior to a discharge apparatus in which the pressure chamber and the dosing chamber are configured as a unitary and not a valve-interrupted chamber. In such a discharge apparatus, it has to be feared, in case of poor design, that the, in the course of actuation, increased pressure in a unitary dosing and pressure chamber results merely in a compression of the residual air present in the unitary dosing and pressure chamber, the pressure not being sufficient, however, to open the discharge valve. Upon the next actuation, this compressed air would be further decompressed and then recompressed, without any change in pressure ratios in the unitary dosing and pressure chamber compared with the previous actuation. Since the air cannot escape, however, it would not be possible to actually start using the dispenser.

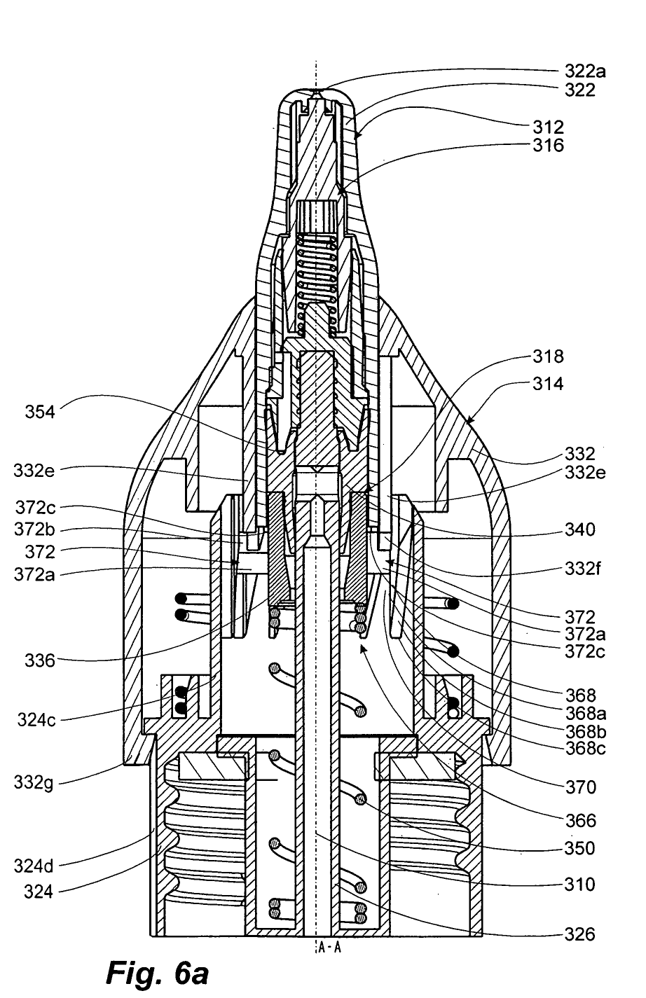

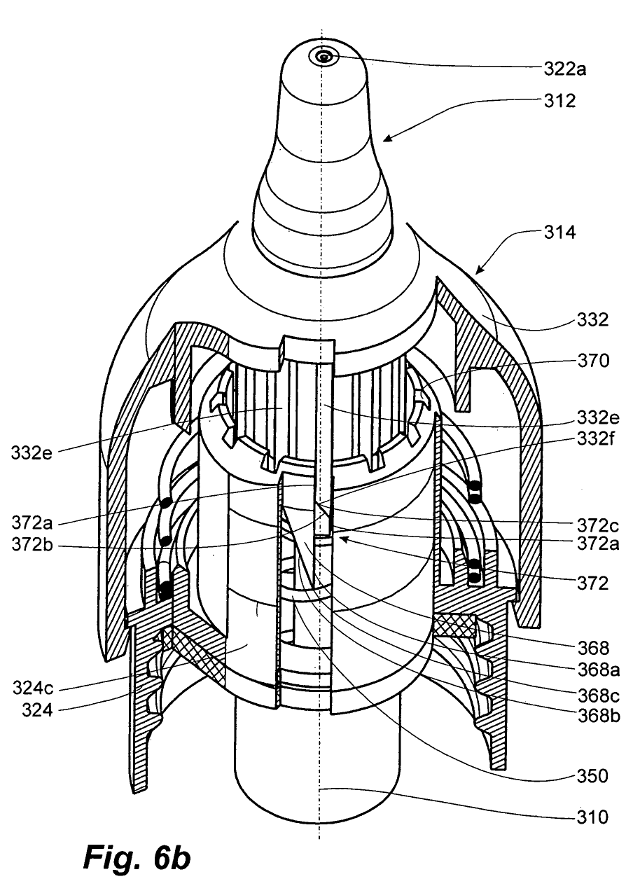

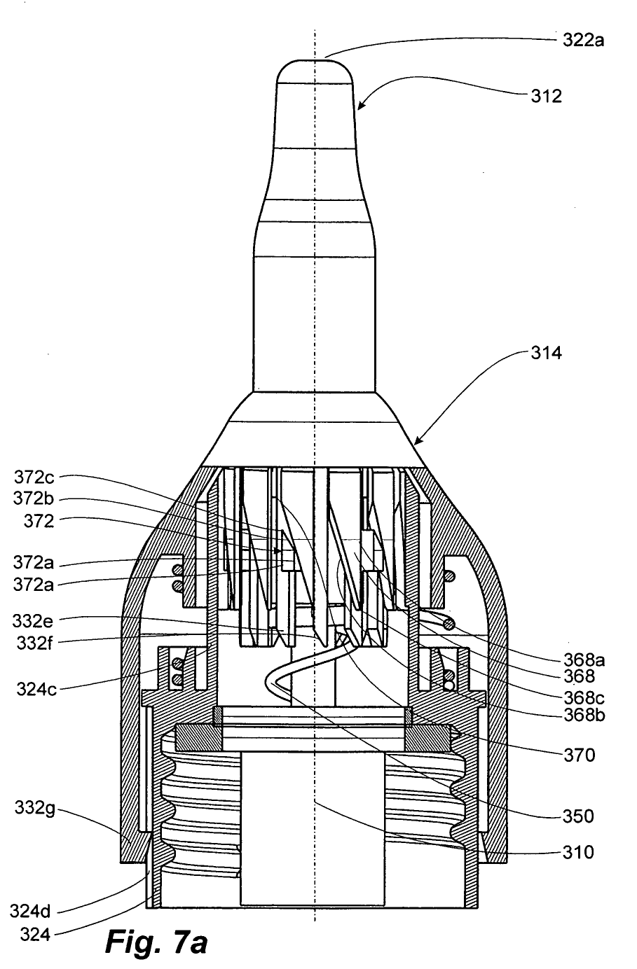

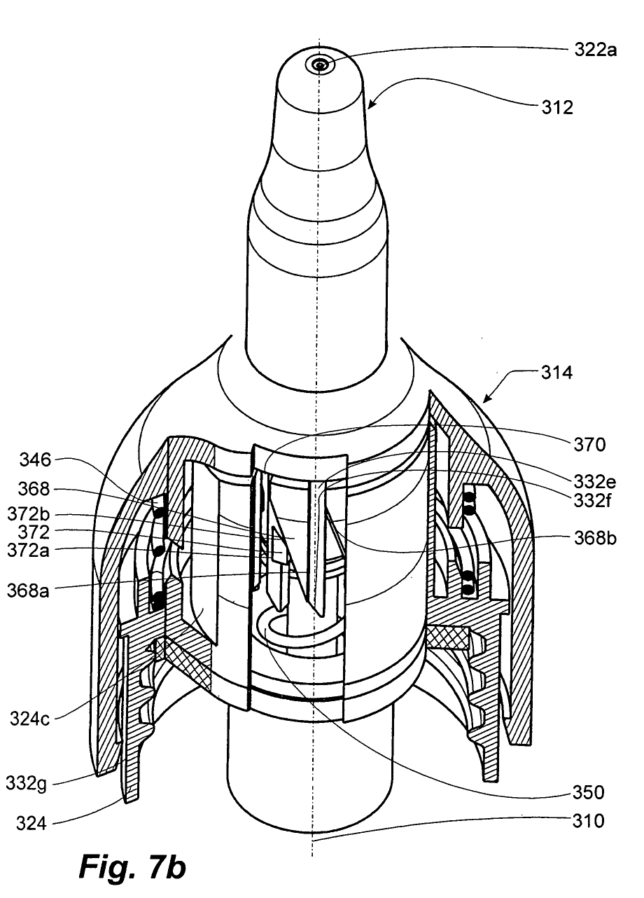

FIGS. 6a and 6b and FIGS. 7a and 7b show a further embodiment of a dispenser according to the invention. The fundamental construction of this fourth embodiment of a dispenser according to the invention is consistent with the construction of the dispensers represented in FIGS. 1 to 5, inasmuch as four mutually separated and axially mutually displaceable subassemblies are likewise provided, constituted by an applicator subassembly 312 fixedly connected to a medium reservoir and comprising a nose applicator 322, a finger rest subassembly 314, a discharge valve subassembly 316 and a piston subassembly 318. The interaction of the finger rest subassembly 314, the applicator subassembly 312 and the piston subassembly 318, and the manner of the conveyance of the medium from the medium reservoir into a dosing chamber 354, here broadly corresponds to the second embodiment represented in FIG. 4. The basic difference to this and all other above-described embodiments lies in the nature of the coupling and decoupling of the finger rest subassembly 314 to/from the piston subassembly 318 in the course of the actuation of the dispenser, and in the motional sequence of the piston subassembly 318 following the decoupling from the finger rest subassembly 314 in the second, lower stroke end position.

FIGS. 6a and 6b, on the one hand, and FIGS. 7a and 7b, on the other hand, respectively show a state of the discharge apparatus, once in a sectioned side view and once in a likewise sectioned view from diagonally above.

In the represented embodiment, the finger rest subassembly 314 comprising a finger rest 332, the applicator subassembly 312 and the piston subassembly 318 are configured such that the movement of the piston subassembly 318 from a second, lower stroke end position into a first, upper stroke end position is realized in the form of a translatory motion in the direction of a principal axis 310, with simultaneous rotary motion about the principal axis 310. While the finger rest subassembly 314 is connected to the applicator subassembly 312 in a rotationally secure manner, so that the finger rest subassembly 312, relative to the applicator subassembly, has only a translatory degree of freedom in the axial direction, the piston subassembly 318 is guided with restricted rotatability on a cylindrical outer surface of a medium supply apparatus 326.

The concrete configuration and the advantages of the coupling and decoupling apparatus of the embodiment represented in FIGS. 6a to 7b are described below.

The applicator subassembly 312 has a cylindrically configured guide section 324c, which is molded onto a screw fastening 324 and the inner side of which is provided with a sawtooth profiling 366. The sawtooth profiling 366 consists of individual sawteeth 368, which, respectively, are mutually separated by grooves 370 extending in the direction of the principal axis 310. The sawteeth 368 respectively have a vertical flank 368a, extending in the direction of the principal axis 310, and a screw-section-shaped control cam flank 368b, configured as a control cam and lying opposite the vertical flank 368a. The sawteeth are respectively identically aligned, so that the control cam flanks 368b, if the control cylindrical section is viewed in the direction of the principal axis 310, are either all in clockwise alignment or all in counterclockwise alignment.

The piston subassembly 318 has a piston packing 340 and a carrier 336. Molded onto the carrier 336 are a total of six vanes 372 extending radially outward, which are spaced 60° apart and have a radial length which makes them jut into the grooves 370. The vanes 372 have a rectangular cross-sectional area, two parallel, mutually opposing support surfaces 372a, corresponding with the grooves 370 in the sawtooth profiling 366, being realized perpendicularly and parallel to the principal axis 310. A third, diagonally upward pointing contact surface 372b is inclined by an angle of about 60° relative to the principal axis 310, the alignment of this contact surface 372b corresponding with the opposite control cam flanks 368b of the sawteeth 368.

The finger rest 332 has a total of twelve circularly arranged pusher arms 332e, respectively spaced 30° apart, which respectively extend identically from the principal axis 310, at a distance apart in the direction of the principal axis 310, from above into the guide cylinder section 324c of the applicator subassembly 312. At their end, the pusher arms 332e respectively have a contact surface 332f, which is tilted relative to the principal axis 310 to the same degree as the contact surfaces 372b of the vanes 372 of the carrier 336. Their direction of tilt herein corresponds to the direction of tilt of the control cam flanks 368b of the sawteeth 368.

As already explained above, the finger rest 332 and the applicator subassembly 312 are mutually connected in a rotationally secure manner. For this purpose, on the screw fastening 324 belonging to the applicator subassembly 312, a groove 324d is provided, in which a securing section 332g of the finger rest 332 engages. The rotational position of the finger rest relative to the guide section 324c is defined such that each pusher arm 332e is assigned a groove 370 and lies opposite this groove.

The carrier 336 is represented in FIGS. 6a and 6b in its first, upper stroke end position. The six vanes 372 of the carrier 336 extend radially outward into the grooves 370 in the sawtooth profiling 366. Since the vanes 372 are spaced respectively 60° apart and the grooves 370 are spaced respectively 30° apart, a vane 372 of the carrier 336 is present in only every second groove 370 in each case. The finger rest 332 is in its upper actuating end position. In this upper actuating end position, the pusher arms 332e extend downward into the guide cylinder section 324c and there bear with their contact surfaces 332f flush against the contact surfaces 372b of the vanes 372 of the carrier 336.

Starting from this starting position, a depression of the finger rest 332 results in the carrier 336, too, being forced downward, since six of the contact surfaces 332f of the pusher arms 332e press upon the contact surfaces 372b of the vanes 372 of the carrier 336. Apart from the force which hence acts upon the carrier 336, downward in the direction of the principal axis 310, the force applied via the finger rest 332 and the pusher arms 332e also causes a torque to be generated, since the carrier 336, in accordance with the alignment of the contact surfaces 372b, 332f and due to its subjection to an upwardly directed spring force by an energy store spring 350, attempts to slide off from pusher arms 332d. This sliding-off is prevented, however, by the vertical tooth flanks 368a of the sawteeth 368 of the sawtooth profile 366. Through the depression of the finger rest 332, the piston subassembly 318 is therefore forced down to the same extent, without any possible change in the rotational position of the piston subassembly 318.

During the depression of the finger rest and of the piston subassembly 318, an underpressure or vacuum comes to be generated in the dosing chamber 354, in the same manner as described in relation to the second embodiment, represented in FIG. 4, whereafter medium, after having reached a through bore 326b through a sealing web 340d which closes off the dosing chamber 354 in the downward direction, proceeds to flow into the dosing chamber 354.

If the finger rest 332, jointly with the piston subassembly 318, is pressed downward to the point where the upward-pointing edges 372c of the vanes 372 of the carrier 336 level with the downward-pointing tips 368c of the sawteeth 368 are reached, the anti-twisting protection for the carrier 336 is no longer present. In a spiral motion, the vanes 372 of the carriers 336 then slide out of engagement with the pusher arms 332e and onto the control cams 372b of the sawteeth 368. On the control cams 372b, the vanes 372 of the carrier 336, upon simultaneous rotation of the carrier 336, then slide on as far as the setting represented in FIGS. 7a and 7b. This produces a diminution of the volume of the dosing chamber 354 and a pressure increase in the medium present therein, so that, in the same manner as in the other embodiments, a discharge operation is initiated. If the finger rest 332 is then returned to its upper actuating end position, the vanes 372 slip back into their starting position in the grooves 370.

Compared with the first to third embodiments, this fourth embodiment has two basic advantages: The represented motional sequence of the carrier 336, and hence of the piston packing 340, leads to a retarded intake stroke in the course of the return stroke motion, by which it is ensured that the filling of the dosing chamber 354 is concluded before the dosing chamber 354 is separated from the medium reservoir by the sealing web 340d of the piston packing 340. This retarded motional sequence ensures that an underpressure is not maintained in the dosing chamber 354 if, at the same time, the target dosage is not reached. The second basic advantage lies in the fact that—unlike in embodiments 1 to 3—no elastic deformation of components is necessary for the coupling/decoupling of the piston subassembly 318 to and from the finger rest 332. The risk of failure of the discharge apparatus, through wear, or breakage of a latch boss or some other elastic component, is thereby reduced.

1. Dispenser for media, especially for nasal application, having
a medium reservoir,
an applicator and at least one discharge opening,
a finger rest, which can be manually subjected to force, and
a pump, having at least two pump parts which are axially movable relative to each other, wherein the applicator is fixedly connected to the medium reservoir and the finger rest is axially movable relative to the medium reservoir and the applicator between a first, non-pressed operating end position and a second, pressed operating end position.

2. Dispenser according to claim 1, wherein the pump is realized in such a way that a constant discharge stroke can be obtained independently of a manual user force.

3. Dispenser according to claim 2, wherein a carrier, which is connected in a non-detachable manner to a pump piston, the applicator (12; 112; 212; 312), the carrier and/or the finger rest having coupling means which are configured to create an axial coupling state between the carrier and the finger rest in the region of a first pump stroke end position assigned to the first operating end position, and to create a decoupled state of carrier and finger rest in the region of a second stroke end position assigned to the second operating end position, and the carrier being subjected to a spring force in the direction of the first stroke end position.

4. Dispenser according to claim 3, wherein the coupling means have time-delay means, by which, following decoupling of the carrier from the finger rest in the region of the second stroke end position, a retarded return stroke motion is obtained.

5. Dispenser according to claim 3, wherein the coupling means on the carrier have at least one latching element, preferably a latch boss, which can be coupled to the finger rest in such a way that a movement of the finger rest from the first operating end position to the second operating end position produces a movement of the carrier from the first pump stroke end position to the second stroke end position, and the coupling means on the applicator have a decoupling section, which, in the region of the stroke end position, decouples the latching means from the finger rest, preferably by radial deflection of the latch boss.

6. Dispenser according to claim 3, wherein the applicator and the finger rest are configured such that they are rotationally secure one to the other with respect to a principal axis, and the carrier, in a first stroke section adjacent to the first stroke end position, at least in a rotational direction about the principal axis, is secured against twisting relative to the applicator, and, in a second stroke section adjacent to the second stroke end position, can be twisted in this rotational direction, guide means being provided, which, following attainment of the state decoupled from the finger rest, guide the carrier in an overlaid rotary and translatory motion back into the first stroke end position.

7. Dispenser according to claim 3, wherein the pump piston fixedly connected to the carrier limits, jointly with a cylindrical pump wall and an end wall of the applicator, a dosing chamber of the pump.

8. Dispenser according to claim 3, wherein the carrier is connected by an inlet valve to the medium reservoir, which, if the dosing chamber pressure is lower than the pressure in the medium reservoir, opens.

9. Dispenser according to claim 3, wherein the carrier and/or the applicator is/are configured such that the dosing chamber, in a first isolating stroke section adjacent to the first stroke end position, is separated from the medium reservoir and, in a thereto adjoining connecting stroke section, is connected to the medium reservoir.

10. Dispenser according to claim 3, wherein the dosing chamber, in a second isolating stroke section preceding the stroke end position, is separated from the medium reservoir.

11. Dispenser according to claim 1, wherein a discharge valve, which is operatively connected to the finger rest by mechanical means and is configured such that it opens in a stroke intermediate position, before the second stroke end position is reached.

12. Dispenser according to claim 7, wherein between the dosing chamber and the discharge opening a pressure chamber is provided, which is separated from the dosing chamber by a pressure-actuated intermediate valve.

13. Dispenser according to claim 11, wherein the discharge valve is configured in such a way that in the open state, from a maintenance limit pressure of the medium in the region of the discharge valve, it maintains the open state, this limit pressure, in the case of a discharge valve actuated by the pressure of the medium, preferably being less than the limit pressure which is necessary to open the valve.

14. Dispenser according to claim 13, wherein the discharge valve has an actuating surface, the pressurized portion of which in the open state of the discharge valve is greater than in the closed state of the discharge valve.
